(19) United States
(12) Patent Application Publication
(10) Pub. No.: US 2020/0022316 A1
(43) Pub. Date: Jan. 23, 2020

(54) ROBOTIC APPLICATORS IN AN ASSEMBLY LINE GROW POD AND METHODS OF PROVIDING FLUIDS AND SEEDS VIA ROBOTIC APPLICATORS

(71) Applicant: Grow Solutions Tech LLC, Vineyard, UT (US)

(72) Inventors: Gary Bret Millar, Highland, UT (US); Michael Tyler Wirig, Pleasant Grove, UT (US)

(21) Appl. No.: 16/515,882

(22) Filed: Jul. 18, 2019

Related U.S. Application Data
(60) Provisional application No. 62/699,768, filed on Jul. 18, 2018.

(51) Int. Cl. A01G 9/02; A01G 31/06; A01G 27/00; A01G 9/029; A01G 9/08

(52) U.S. Cl. CPC A01G 9/027; A01G 31/06; A01G 9/085; A01G 27/008; A01G 9/029; A01G 9/022

(57) ABSTRACT

Assembly line grow pods, watering stations, and seeder components that include robotic applicators are disclosed. An assembly line grow pod includes a tray held by a cart supported on a track. The tray includes a plurality of sections. The assembly line grow pod further includes a watering component providing fluid and a robotic applicator including an articulating robot arm having one or more outlets that selectively dispense the fluid therefrom. The articulating robot arm is positioned to align the one or more outlets with a corresponding one or more of the plurality of sections such that the fluid is dispensable into each of the plurality of sections independently.

### CROSS-REFERENCE TO RELATED APPLICATION

This application claims priority to U.S. Provisional Patent Application Ser. No. 62/699,768, entitled “ROBOTIC APPLICATORS IN AN ASSEMBLY LINE GROW POD AND METHODS OF PROVIDING FLUIDS AND SEEDS VIA ROBOTIC APPLICATORS” and filed Jul. 18, 2018, the entire contents of which is incorporated herein.

### TECHNICAL FIELD

Embodiments described herein generally relate to systems and methods for providing fluids and/or seeds (e.g., a slurry of fluid and seeds) in an assembly line grow pod and, more specifically, to use of one or more robotic applicators to supply fluids and/or seeds.

### BACKGROUND

Current plant growing assemblies, such as greenhouses, grow houses, and/or the like, may grow crops in a controlled environment. To ensure correct operation of a greenhouse, these current solutions may control the amounts of seeds that are planted and/or the amount of fluids that are supplied to the seeds. Current solutions may provide watering and nutrient distribution, but fail to provide specific and customized water and seed distribution to trays to ensure accurate and targeted growth according to one or more recipes.

### SUMMARY

In a first aspect, an assembly line grow pod includes a tray held by a cart supported on a track. The tray includes a plurality of sections. The assembly line grow pod further includes a watering component providing fluid and a robotic applicator including an articulating robot arm having one or more outlets that selectively dispense the fluid therefrom. The articulating robot arm may be positioned relative to the tray to align the one or more outlets with a corresponding one or more of the plurality of sections such that the fluid is dispensable into each of the plurality of sections independently.

In a second aspect, a watering station adjacent to a track carrying a cart supporting a tray includes a robotic applicator having an articulating robot arm coupled to a movable base. The watering station further includes a plurality of outlets fluidly coupled to a watering component. The watering component provides fluid. The watering station further includes a sensor positioned to sense a location of one or more sections of a plurality sections of the tray. The articulating robot arm may be positioned to align at least one of the plurality of outlets with the one or more of the plurality of sections of the tray such that a predetermined amount of the fluid is distributed by the at least one of the plurality of outlets into the plurality of sections of the tray independently.

In a third aspect, a method of providing fluid to a tray in an assembly line grow pod includes receiving, by a master controller of the assembly line grow pod, data pertaining to the tray from a sensor communicatively coupled to the master controller. The method further includes determining, by the master controller, one or more sections of a plurality of sections of the tray in need of fluid based on a grow recipe. The method further includes includes directing, by the master controller, fluid to be dispensed from the one or more outlets of the robot arm into the one or more sections of the tray.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts a front perspective view of an illustrative assembly line grow pod according to one or more embodiments shown and described herein;

FIG. 1B schematically depicts a rear perspective view of a portion of an illustrative assembly line grow pod according to one or more embodiments shown and described herein;

FIG. 2 depicts a top view of an illustrative tray that is used for holding plant material according to one or more embodiments shown and described herein;

FIG. 3 depicts a side perspective view of an illustrative robotic applicator above a tray according to one or more embodiments shown and described herein;

FIG. 4 depicts a top perspective view of the robotic applicator depicted in FIG. 3;

FIG. 5 schematically depicts an illustrative network including a master controller communicatively coupled to a robotic applicator and a sensor according to one or more embodiments shown and described herein;

FIG. 6 schematically depicts an illustrative computing environment within a master controller according to one or more embodiments shown and described herein;

FIG. 7A depicts a robot arm in a retracted position according to one or more embodiments shown and described herein;

FIG. 7B depicts movement of segments of a robot arm to extend the robot arm according to one or more embodiment shown and described herein;

FIG. 7C depicts additional movement of segments of a robot arm to extend the robot arm according to one or more embodiments shown and described herein;

FIG. 7D depicts yet additional movement of segments of a robot arm to extend the robot arm according to one or more embodiments shown and described herein;

FIG. 8 depicts a flow diagram of an illustrative method of providing a robotic applicator in an assembly line grow pod according to one or more embodiments shown and described herein;

FIG. 9 depicts a flow diagram of an illustrative overview method of providing seeds or fluid to a tray via a robotic applicator in an assembly line grow pod according to one or more embodiments shown and described herein; and

FIG. 10 depicts a flow diagram of an illustrative method of providing seeds or fluid to a tray using a robotic applicator according to one or more embodiments shown and described herein.

### DETAILED DESCRIPTION

Embodiments disclosed herein include devices, systems, and methods for distributing a precise amount of fluid and/or seeds (e.g., a slurry of fluid and seeds) to a tray (and/or one or more sections thereof) on a cart supported on a track in an assembly line grow pod using a robotic applicator, such as a robot arm or the like. The assembly line grow pod may include a plurality of carts that follow the track. The robotic applicator directs a specific amount of water, nutrients, and/or seeds (e.g., a slurry of water and seeds) are supplied to specific sections of the trays as the trays traverse the track, such that the trays may receive and/or hold plant material.

It should be understood that the term seed may be used interchangeably with the term plant herein. Specifically, as seeds will develop into plants, different embodiments may pre-germinate the seeds received by a tray and thus those embodiments may or may not be in seed form. Similarly, the phrase plant material may be utilized herein to refer to both seed forms and plant forms of a plant.

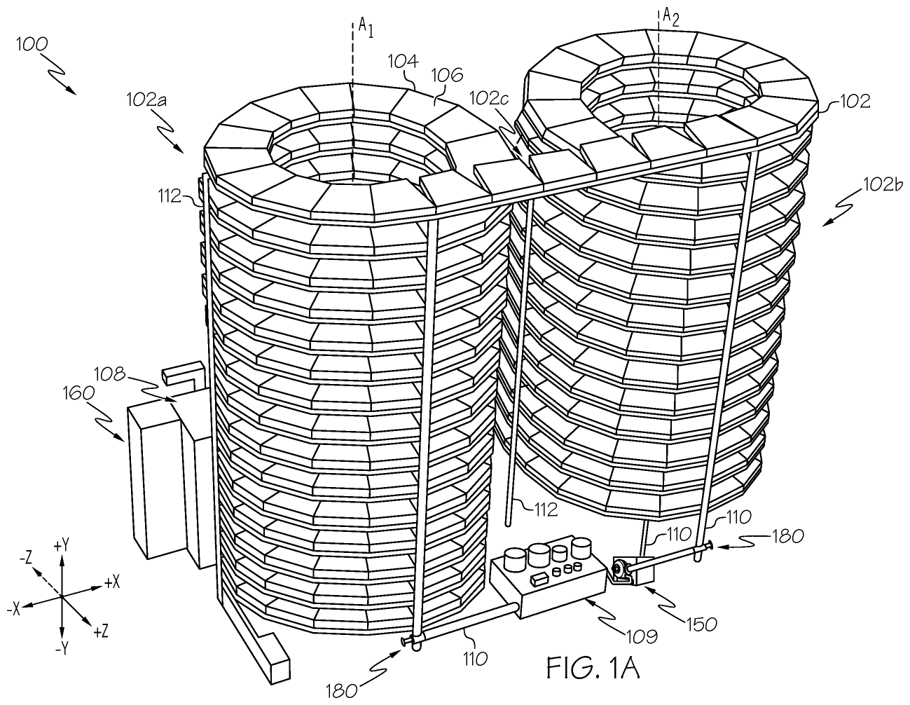

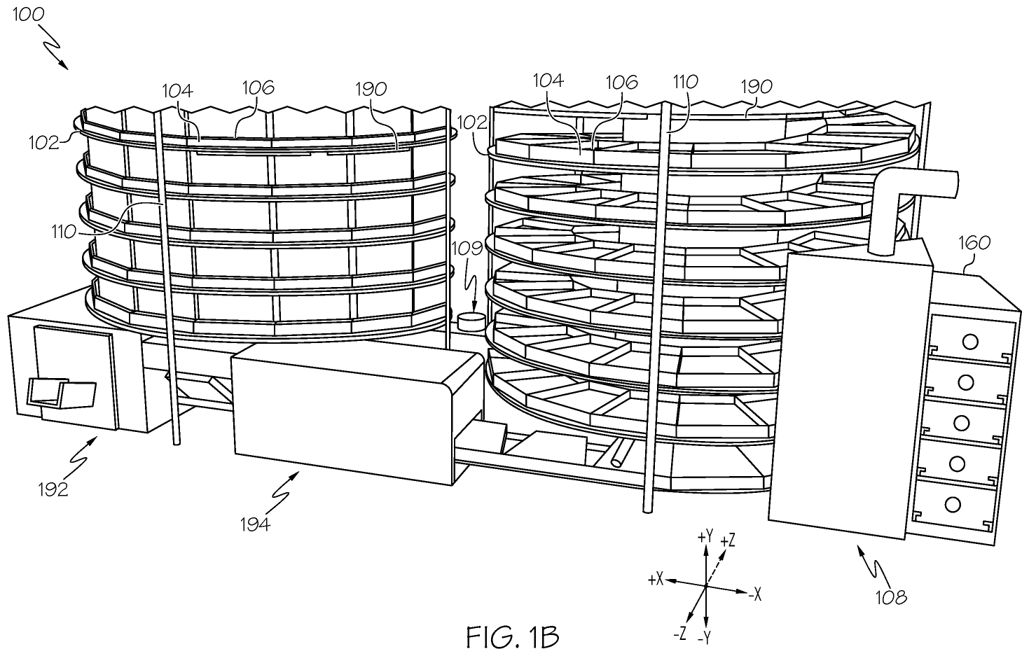

An illustrative industrial grow pod that allows for the continuous, uninterrupted growing of crops is depicted herein. Particularly, FIG. 1A depicts a front perspective view of an illustrative assembly line grow pod 100 according to one or more embodiments shown and described herein. In addition, FIG. 1B depicts a rear perspective view of a portion of the assembly line grow pod 100. As illustrated in FIGS. 1A and 1B, the assembly line grow pod 100 may include a track 102 that supports one or more carts 104 thereon. Referring particularly to FIG. 1A, the track 102 may include at least an ascending portion 102a, a descending portion 102b, and a connection portion 102c. The track 102 may wrap around (e.g., in a counterclockwise direction, as shown in FIG. 1A) a first axis A₁ such that the carts 104 ascend upward in a vertical direction (e.g., in the +y direction of the coordinate axes of FIG. 1A). The connection portion 102c may be relatively level (although this is not a requirement) and is utilized to transfer carts 104 to the descending portion 102b. The descending portion 102b may be wrapped around a second axis A₂ (e.g., in a counterclockwise direction, as shown in FIG. 1A) that is substantially parallel to the first axis A₁, such that the carts 104 may be returned closer to a ground level.

It should be understood that while the embodiment of FIGS. 1A and 1B depict an assembly line grow pod 100 that wraps around a plurality of axes A₁, A₂, this is merely one example. Any configuration of assembly line or stationary grow pod may be utilized for performing the functionality described herein.

The ascending portion 102a and the descending portion 102b may allow the track 102 to extend a relatively long distance while occupying a comparatively small footprint evaluated in the x-direction and the z-direction as depicted in the coordinate axes of FIG. 1A, as compared to assembly line grow pods that do not include an ascending portion 102a and a descending portion 102b. Minimizing the footprint of the assembly line grow pod 100 may be advantageous in certain applications, such as when the assembly line grow pod 100 is positioned in a crowded urban center or in other locations in which space may be limited and/or the cost of land is expensive.

Referring to FIG. 1A, supported on each one of the carts 104 is a tray 106. The tray 106 may generally contain one or more components for holding seeds as the seeds germinate and grow into plants as the cart 104 traverses the ascending portion 102a, the descending portion 102b, and the connection portion 102c of the track 102 of the assembly line grow pod 100. The seeds may be pre-soaked, planted, allowed to grow, and then may be harvested by various components of the assembly line grow pod 100, as described in greater detail herein. In addition, the seeds (and thereafter the shoots and plants) within the trays 106 may be monitored, provided with water, nutrients, environmental conditions, light, and/or the like to facilitate growing.

Also depicted in FIGS. 1A and 1B is a master controller 160. The master controller 160 may include, among other things, control hardware for controlling various components of the assembly line grow pod 100, as described in greater detail herein. In some embodiments, the master controller 160 may be particularly configured to control operation of one or more robotic applicators, as described in greater detail herein.

Coupled to the master controller 160 is a seeder component 108. The seeder component 108 may contain a seed source (e.g., a seed hopper, slurry source, or the like) that provides seeds (or a slurry containing seeds) and components (e.g., one or more robotic applicators) that are configured to place seeds (or a slurry containing seeds) in the trays 106 supported on the one or more carts 104 as the carts 104 pass the seeder component 108 in the assembly line. Depending on the particular embodiment, each cart 104 may include a single section tray 106 for receiving a plurality of seeds. Some embodiments may include a multiple section tray 106 for receiving individual seeds in each section (or cell). In the embodiments with a single section tray 106, the seeder component 108 may detect the presence of the respective cart 104 and may begin laying seed across an area of the single section tray 106. The seed may be laid out according to a desired depth of seed, a desired number of seeds, a desired surface area of seeds, a size of a section of the tray 106, and/or according to other criteria. In some embodiments, the seeds may be pre-treated with nutrients and/or other agents (such as water) to create a slurry (e.g., a semiliquid mixture) that contains the seeds. Depending on the particular embodiment, the seeds may not utilize soil to grow. Such a pre-treatment of seeds may be completed by one or more peristaltic pumps. Additional details regarding deposition of fluid (e.g., water, nutrients, and/or the like) and seeds will be described in greater detail below.

In the embodiments where a multiple section tray 106 is utilized with one or more of the carts 104, the seeder component 108 may be configured to individually insert seeds into one or more of the sections of the tray 106. Again, the seeds may be distributed on the tray 106 (or into individual sections/cells) according to a desired number of seeds, a desired area the seeds should cover, a desired depth of seeds, etc. Distribution of seeds may be completed via a robotic applicator, such as the robotic applicator described in greater detail herein.

Referring to FIG. 1A, the assembly line grow pod 100 may also include a watering component 109 coupled to one or more fluid lines 110 (e.g., water lines) via one or more fluid pumps 150 and/or one or more flow control valves 180 in some embodiments. The watering component 109 may generally be a source of fluid that is distributed as described herein. As such, the watering component 109 may include one or more fluid storage tanks, such as, for example, one or more water storage tanks and/or one or more nutrient storage tanks. Other sources of fluid that are provided by the watering component 109 should generally be understood and are included within the scope of the present disclosure. While only a single fluid pump 150 is depicted in FIG. 1A, it should be understood that the assembly line grow pod 100 may incorporate a plurality of fluid pumps 150 in some embodiments. Likewise, while a plurality of flow control valves 180 are depicted in FIG. 1A, it should be understood that the assembly line grow pod 100 may incorporate a single flow control valve 180 in some embodiments. The watering component 109, the one or more fluid pumps 150, the one or more flow control valves 180, and the one or more fluid lines 110 may distribute water and/or nutrients to one or more robotic applicators (not shown) located at various locations within the assembly line grow pod 100, which then move to facilitate distribution of a precise amount of water and/or nutrients to trays 106 as described in greater detail herein. Additional details regarding the one or more robotic applicators will be described in greater detail hereinbelow. In some embodiments, the master controller 160 may be communicatively coupled to the watering component 109, the one or more fluid pumps 150, and the one or more flow control valves 180 such that the master controller 160 transmits signals for the operation of the watering component 109, the one or more fluid pumps 150, and the one or more flow control valves 180 to selectively control flow and/or pressure of fluid accordingly.

Also depicted in FIG. 1A are airflow lines 112, which may also be fluidly connected to one or more air pumps and/or one or more air valves (not shown in FIG. 1A). Specifically, the one or more air pumps may be similar to fluid pumps 150, but are coupled to the airflow lines 112 to deliver air to one or more portions of the assembly line grow pod 100, pressurize air, depressurize air, and/or the like. In addition, the one or more air valves may be valves that are similar to the flow control valves 180, but are coupled to the airflow lines 112 to direct airflow to one or more portions of the assembly line grow pod 100. The air may be delivered, for example, to control a temperature of the assembly line grow pod 100 or an area thereof, a pressure of the air in the assembly line grow pod 100 or an area thereof, control a concentration of carbon dioxide (CO₂) in the air of the assembly line grow pod 100 or an area thereof, control a concentration of oxygen (O₂) in the air of the assembly line grow pod 100 or an area thereof, control a concentration of nitrogen (N₂) in the air of the assembly line grow pod 100 or an area thereof, and/or the like.

Referring to FIG. 1B, additional components of the assembly line grow pod 100 are illustrated, including (but not limited to) one or more lighting devices 190, a harvester component 192, and a sanitizer component 194. While also referring to FIG. 1A, the lighting devices 190 may provide light that may facilitate plant growth at various locations throughout the assembly line grow pod 100 as the carts 104 traverse the track 102. Depending on the particular embodiment, the lighting devices 190 may be stationary and/or movable. As an example, some embodiments may alter the position of the lighting devices 190, based on the plant type, stage of development, recipe, and/or other factors.

Additionally, as the plants are provided with light, provided with water, and provided nutrients, the carts 104 traverse the track 102 of the assembly line grow pod 100. Additionally, the assembly line grow pod 100 may detect a growth and/or other output of a plant and may determine when harvesting is warranted. If harvesting is warranted prior to the cart 104 reaching the harvester component 192, modifications to a grow recipe may be made for that particular cart 104 until the cart 104 reaches the harvester component 192. Conversely, if a cart 104 reaches the harvester component 192 and it has been determined that the plants in the cart 104 are not ready for harvesting, the assembly line grow pod 100 may commission the cart 104 for another lap. This additional lap may include a different dosing of light, water, nutrients, etc. and the speed of the cart 104 could change, based on the development of the plants on the cart 104. If it is determined that the plants on a cart 104 are ready for harvesting, the harvester component 192 may harvest the plants from the trays 106.

Referring to FIG. 1B, the harvester component 192 may cut the plants at a particular height for harvesting in some embodiments. In some embodiments, the tray 106 may be overturned to remove the plants from the tray 106 and into a processing container for chopping, mashing, juicing, and/or the like. Because many embodiments of the assembly line grow pod 100 do not use soil, minimal (or no) washing of the plants may be necessary prior to processing.

Similarly, some embodiments may be configured to automatically separate fruit from the plant, such as via shaking, combing, etc. If the remaining plant material may be reused to grow additional fruit, the cart 104 may keep the remaining plant and return to the growing portion of the assembly line. If the plant material is not to be reused to grow additional fruit, it may be discarded or processed, as appropriate.

Once the cart 104 and tray 106 are clear of plant material, the sanitizer component 194 may remove any particulate matter, plant material, and/or the like that may remain on the cart 104. As such, the sanitizer component 194 may implement any of a plurality of different washing mechanisms, such as high pressure water, high temperature water, and/or other solutions for cleaning the cart 104 and/or the tray 106. As such, the sanitizer component 194 may be fluidly coupled to one or more of the fluid lines 110 to receive water that is pumped via the one or more fluid pumps 150 and directed via the one or more flow control valves 180 (FIG. 1A) through the fluid lines 110.

Still referring to FIG. 1B, the tray 106 may be overturned to output the plant for processing and the tray 106 may remain in this position in some embodiments. As such, the sanitizer component 194 may receive the tray 106 in this position, which may wash the cart 104 and/or the tray 106 and return the tray 106 back to the growing position. Once the cart 104 and/or tray 106 are cleaned, the tray 106 may again pass the seeder component 108, which may determine that the tray 106 requires seeding and may begin the process placing seeds in the tray 106, as described herein.

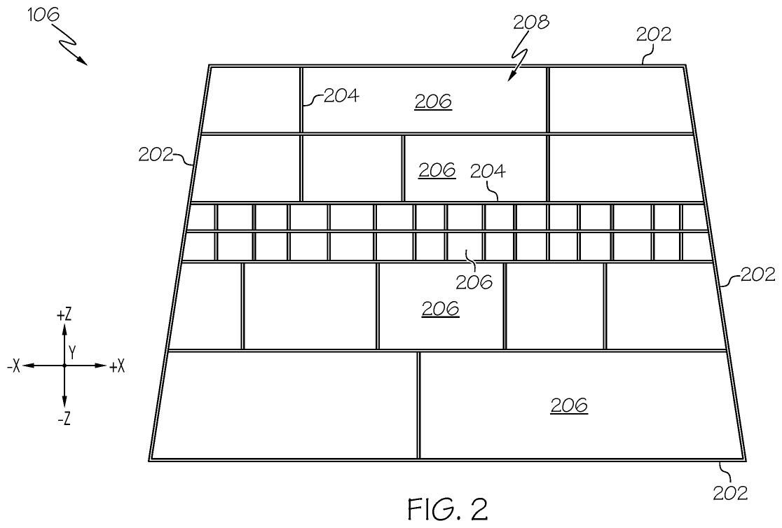

Referring now to FIG. 2, a top view of the tray 106 is depicted according to various embodiments. Referring to FIGS. 1A and 2, as previously described herein, the tray 106 may have a plurality of physical sections 206 (also referred to as cells) therein for holding plant material as the cart 104 holding the tray 106 traverses the track 102 within the assembly line grow pod 100. Referring again to FIG. 2, the tray 106 may have a plurality of side walls 202 (e.g., a first side wall, a second side wall, a third side wall, and a fourth side wall) that define the outer edges of the tray 106 and further define a cavity 208 within the tray 106 that holds the plant material therein. While the embodiment of FIG. 2 depicts four side walls 202, the side walls 202 are not limited in number, size, or arrangement by the present disclosure. As shown in the embodiment in FIG. 2, the side walls 202 may be arranged and sized to form a generally trapezoidal shaped tray 106. That is, two side walls 202 may be arranged substantially parallel to one another along the x-axis of the coordinate axes depicted in FIG. 2, and two other side walls 202 may be arranged such that they are mirror images of one another along the z-axis of the coordinate axes of FIG. 2. However, other shapes and sizes are also contemplated.

In addition to the plurality of side walls 202, the tray 106 may further include a plurality of interior walls 204 that extend along at least a portion of the cavity 208 in some embodiments. That is, at least one of the plurality of interior walls 204 may extend between two of the plurality of side walls 202 (e.g., an interior wall 204 may extend from a first side wall to a second side wall). In some embodiments, at least one of the plurality of interior walls 204 may extend a distance within the cavity 208, but may not extend an entire distance between two of the plurality of side walls 202. In various embodiments, the interior walls 204 are shaped, sized, and arranged to define the plurality of physical sections 206 within the cavity 208 of the tray 106. The physical sections 206 are not limited by this disclosure, and may be any shape or size within the tray 106. In some embodiments, the tray 106 may include a plurality of identically-shaped and sized physical sections 206. For example, the tray 106 may include a honeycomb-like arrangement of sections that are all the same size and shape.

In other embodiments, such as the embodiment depicted in FIG. 2, the tray 106 may include a plurality of different sized and shaped physical sections 206. That is, not all of the physical sections 206 are identically shaped and/or sized. Rather, one or more physical sections 206 may have a first shape and/or size and one or more other physical sections 206 may have a second shape and/or size. In such embodiments, the differently shaped and/or sized physical sections 206 may generally allow for different amounts of seeds to be held by each physical section 206 according to a predetermined seed density recipe, different amounts of fluid (including water and/or nutrients) to be received by each physical section 206 according to a predetermined watering and/or nutrient distribution recipe, different types of plant material to be held by each physical section 206, plant material at differing stages of growth to be held by each physical section 206, and/or the like. Without such differently sized physical sections 206, the seeds, fluids, types of plant material, stage of growth, and/or the like may remain consistent throughout the entire cavity 208,. For example, if the particular tray 106 is utilized for the purposes of testing to determine which of a plurality of seed densities, seed types, amounts of fluid, and/or the like provides the most advantageous results (for example, the quickest plant growth), it may be advantageous to test for multiple variables at once in a single tray instead of a plurality of trays, which may waste material and/or resources, and/or may be inefficient and excessively time consuming. In such embodiments containing differently shaped and/or sized physical sections 206, accurate distribution of the particular amounts of seeds and/or fluid to each differently shaped and/or sized section 206 may be completed using a robotic applicator including a robot arm, as described in greater detail herein.

While the present disclosure depicts a plurality of physical sections 206 within the cavity 208, this is merely an illustrative embodiment. That is, in some embodiments, the tray 106 may not include interior dividing walls. More specifically, the cavity 208 may be open such that a plurality of sections do not exist (e.g., the cavity 208 is a single physical section). In such embodiments, the master controller 160 may be configured to create and/or utilize a plurality of virtual sections of the tray 106, which represent a matrix of watering areas within the tray. The virtual sections may be determined via the master controller 160, and or may be part of a grow recipe determined based on the type and/or size of the tray 106. Regardless, these embodiments may be configured to provide only enough water in each virtual section to fulfill the plant material in that virtual section. This dispensing of water may only be a droplet or plurality of droplets (or more depending on the embodiment), which saves water usage while increasing plant growth. Additionally, some embodiments may utilize physical sections 206 and virtual sections. In such embodiments, there may be reasons to physically divide sections of plant materials, but the watering may be determined based on the virtual sections.

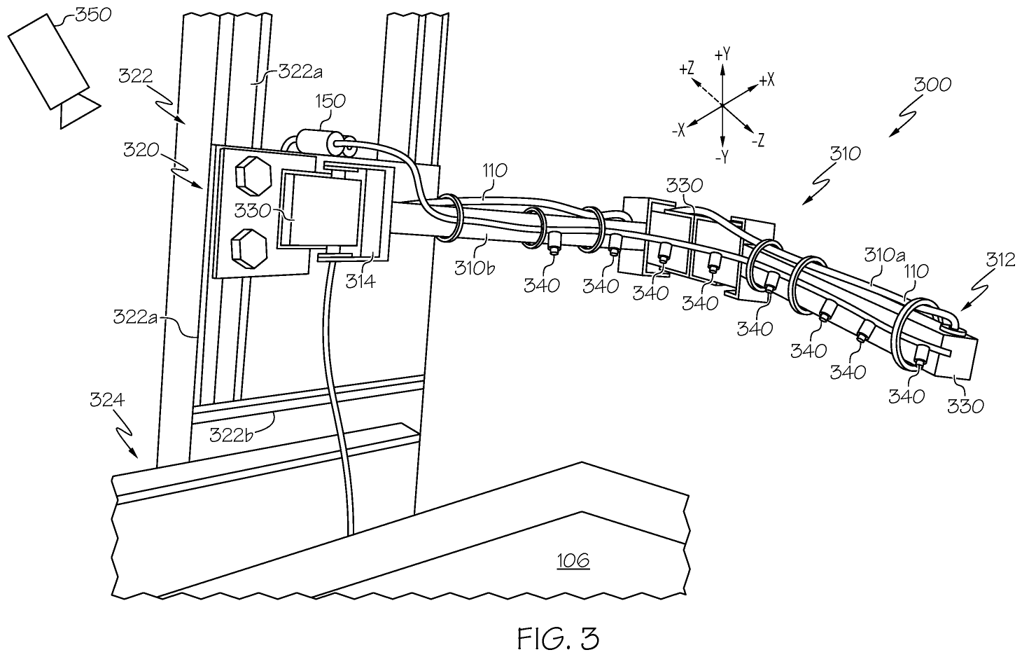

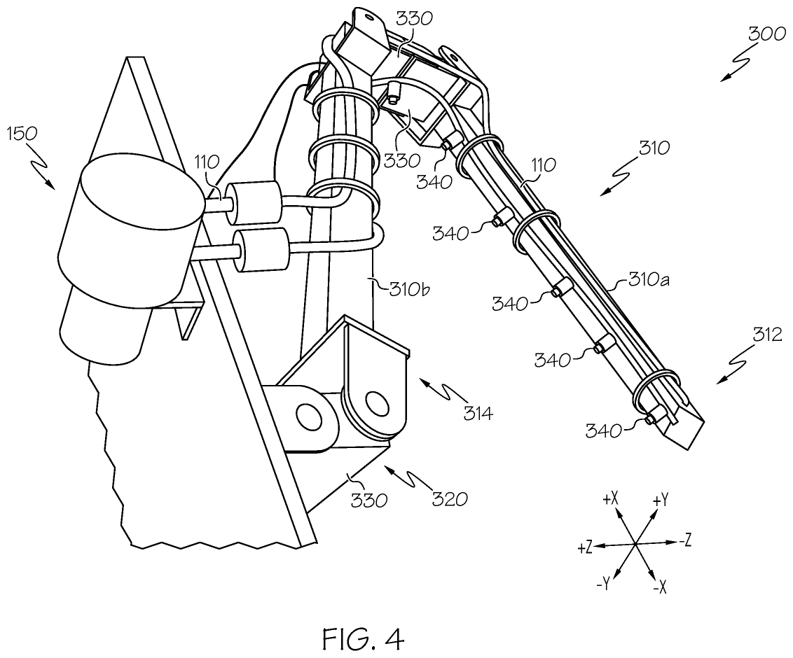

Referring now to FIGS. 3-4, a robotic applicator 300 within the assembly line grow pod 100 (FIG. 1A) is shown. The robotic applicator 300 includes an articulating robot arm 310 having a distal end 312 spaced a distance from a proximal end 314 thereof. In embodiments, the proximal end 314 is mounted to a base 320. In some embodiments, the base 320 may be fixed (e.g., immovable). In other embodiments, the base 320 may be movable on one or more rails 322 mounted to a support 324, such as, for example, vertical rails 322a and/or horizontal rails 322b that allow the base 320 to move in a system vertical direction (e.g., along the +y/−y axis of the coordinate axes of FIGS. 3-4) and/or in a horizontal direction (e.g., along the +x/−x axis of the coordinate axes of FIGS. 3-4).

In some embodiments, the articulating robot arm 310 may have one or more segments that move relative to one another to provide articulating capabilities. The embodiment of FIGS. 3-4, for example, depict a first segment 310a and a second segment 310b. Each segment 310a, 310b of the articulating robot arm 310 may be hingedly coupled to other components via a joint to allow each segment to articulate relative to the other segments and/or other components so that the articulating robot arm 310 has a plurality of ranges of motion to precisely position outlets 340 over the tray 106 (e.g., to align one or more of the outlets 340 with a particular section 206 (FIG. 2)), as described in greater detail herein. For example, the first segment 310a may be hingedly coupled to the second segment 310b via a joint such that the first segment 310a is movable relative to the second segment 310b in an articulating manner. In addition, the second segment 310b may be hingedly coupled to the base 320 via a joint such that the second segment 310b is movable relative to the base 320 in an articulating manner. Control of movement of the various segments of the articulating robot arm 310 may be completed via one or more actuators 330. For example, FIGS. 3-4 depict actuators 330 positioned at a joint between the first segment 310a and the second segment 310b and a joint between the second segment 310b and the base 320. The actuators 330 are not limited in this disclosure by type, size, or location. Illustrative examples of actuators include, but are not limited to, servo motors, stepper motors, screw type actuators, and/or the like. As will be described in greater detail herein, each of the actuators 330 may be communicatively coupled to one or more control components that direct movement of the actuators 330 so as to precisely place and position the articulating robot arm 310 relative to the tray 106 or a portion thereof.

In embodiments, the articulating robot arm 310 generally supports one or more outlets 340 that are open to the tray 106 below such that fluid and/or seeds can be distributed to the tray 106, as described herein. That is, the one or more outlets 340 may be physically coupled to the articulating robot arm 310 and fluidly coupled to a supply line, such as a seed supply line or the fluid line 110 depicted in the embodiment of FIG. 3. As such, fluid or seeds (or a combination thereof, such as a slurry of water and seeds), when supplied via the supply lines (e.g., the fluid line 110) may be ejected from the one or more outlets 340 into the tray 106 (and/or one or more portions thereof). In some embodiments, the one or more outlets 340 may be located on an underside of the articulating robot arm 310 such that the fluid or seeds (or a combination thereof, such as a slurry of water and seeds), when ejected from an outlet 340, fall under force of gravity into the tray 106. In some embodiments, the fluid may be allowed to fall under force of gravity (e.g., dripped) to avoid altering an ambient humidity of the environment in which the tray 106 is located, to avoid altering a humidity of a slurry containing the seeds, and/or to minimize an amount of water that is used, relative to other fluid deposition systems. In some embodiments, the supply lines (e.g., the seed supply line or the fluid line 110) may be physically coupled to the articulating robot arm 310 (e.g., on an underside of the articulating robot arm 310) and the one or more outlets 340 may be openings in the supply lines.

In the embodiment depicted in FIG. 3, each of the one or more outlets 340 may be a nozzle or the like that selectively opens to dispense fluid or seed (or a combination thereof, such as a slurry of water and seeds) therefrom. That is, each of the one or more outlets 340 may be controllable to open or close an aperture or the like. Various features that can be utilized to selectively control movement of fluid or seeds (or a combination thereof, such as a slurry of water and seeds) through each of the one or more outlets 340 should generally be understood and are not described in further detail herein. In embodiments, each of the one or more outlets 340 (or one or more components thereof, such as an actuator controlling an aperture or the like) may be communicatively coupled to one or more control devices that selectively control opening/closing of the one or more outlets 340, thereby selectively controlling fluid or seeds (or a combination thereof, such as a slurry of water and seeds) dispensed therefrom.

In some embodiments, the one or more outlets 340 may be coupled to both the supply lines supplying seeds and the fluid line 110 supplying fluid such that each of the one or more outlets 340 can dispense fluid and seed therefrom. In other embodiments, a first subset of the one or more outlets 340 may be coupled to the supply lines supplying seeds and a second subset of the one or more outlets 340 may be coupled to the fluid line 110 supplying fluid such that the first subset is used only to dispense seeds and the second subset is used only to dispense fluid.

While the embodiment of FIG. 3 depicts eight (8) outlets 340 disposed along a length of the articulating robot arm 310 (including along a length of the first segment 310a and the second segment 310b thereof), the present disclosure is not limited to such an embodiment. That is, any number of outlets 340 may be included without departing from the scope of the present disclosure. In addition, all of the one or more outlets 340 may be disposed on the first segment 310a only in some embodiments. Alternatively, all of the one or more outlets 340 may be disposed on the second segment 310b only in some embodiments.

In some embodiments, the base 320 may be fixed in position such that the base 320 does not move. Rather, the articulating robot arm 310 moves relative to the base 320 to precisely position the outlets 340 over the tray 106. In other embodiments, the base 320 may be movable to move the entire articulating robot arm 310 relative to the tray 106. For example, the base 320 may be vertically movable (e.g., movable in the +y/−y directions of the coordinate axes of FIG. 3) along the one or more vertical rails 322a to position the articulating robot arm 310 closer to or further from the tray 106. In another example, the base 320 may be laterally movable (e.g., movable in the −x/+x directions of the coordinate axes of FIG. 3) along the one or more horizontal rails 322b to position the articulating robot arm 310 over a portion of the tray 106. In yet another example, the base 320 may be laterally movable and vertically movable along the rails 322 (e.g., the vertical rails 322a and/or the horizontal rails 322b) to position the articulating robot arm 310 relative to the tray 106. In some embodiments, the base 320 may include a tilting mechanism (not shown) to tilt the articulating robot arm 310 at an angle relative to the tray 106.

Referring again to FIGS. 3-4, the robotic applicator 300 may further include one or more of the fluid pumps 150 coupled thereto. More specifically, an illustrative one of the fluid pumps 150 is supported on the base 320 and is fluidly coupled to the outlets 340 on the articulating robot arm 310 via the fluid lines 110 in the embodiments depicted in FIGS. 3-4. However, it should be understood that the fluid pump 150 may also be arranged in other locations without departing from the scope of the present disclosure. Further, it should be understood that in embodiments where seeds are supplied by the robotic applicator 300, the fluid pump 150 may not be present. Rather, a seed distribution component that distributes seeds to the outlets 340 via a fluid connection between the seed distribution component and the outlets 340 may be provided.

In embodiments, the fluid pump 150 supported by the base 320 of the robotic applicator 300 in the embodiment of FIGS. 3-4 functions within a watering station as a portion of the water distribution component to supply fluid (e.g., water, nutrients, etc.) to the physical sections 206 (FIG. 2) within the tray 106. That is, the fluid pump 150, together with the components of the robotic applicator 300 may be contained within a watering station that receives water from the watering component 109 (FIG. 1A) and provides the water to various portions of the tray 106 according to a grow recipe (which may include one or more of the following: a watering schedule or a fluid supply recipe, a lighting recipe, etc.). Depending on the particular embodiment, the grow recipe may be configured to statically identify when watering will occur (e.g., every hour, every cycle, etc.) and/or dynamically identify when watering will occur (e.g., based on sensor output that plants and/or seeds on a section of the tray appear drier than desired). The fluid pump 150 is otherwise not limited by the present disclosure, and may incorporate any mechanism for pumping fluid. Illustrative examples include positive displacement pumps such as rotary-type, reciprocating-type, and linear-type positive displacement pumps, impulse pumps, hydraulic ram pumps, velocity pumps, gravity pumps, and/or the like.

Referring again to FIG. 3, a sensor 350 is also depicted. The sensor 350 may generally be arranged to sense various characteristics of the tray 106 and the contents therein. For example, the sensor 350 may be arranged to sense a size, shape, and location of each physical section 206 (FIG. 2) within the tray 106, the location of the interior walls 204 that form the physical sections 206, a presence, type, and/or amount of growth of plant material within the tray 106, and/or the like. In some embodiments, the sensor 350 may be adapted to detect a humidity of ambient air surrounding the tray 106 (or a portion thereof) and/or a humidity of a slurry within the tray 106 (or a portion/region thereof). In some embodiments, the sensor 350 may be physically coupled to one or more components of the robotic applicator 300 and positioned such that a field of view of the sensor 350 contains one or more of the components of the robotic applicator 300 (e.g., the outlets 340) and/or at least a portion of the tray 106. For example, the sensor 350 may comprise a plurality of fiber optic cables that terminate at or near the articulating robot arm 310, which are coupled to an image processing device such that images of an area surrounding the articulating robot arm 310 (e.g., an area underneath the articulating robot arm 310) are captured by the image processing device via the fiber optic cables. In other embodiments, the sensor 350 may be located adjacent to the robotic applicator 300 and positioned such that the field of view of the sensor 350 contains one or more of the components of the robotic applicator 300 (e.g., the outlets 340) and/or at least a portion of the tray 106. The sensor 350 is communicatively coupled to various other components of the assembly line grow pod 100 (FIG. 1A) such that signals, data, and/or the like can be transmitted between the sensor 350 and/or the other components, as described in greater detail herein. For example, the sensor 350 may be communicatively coupled to one or more components that receive the image data from the sensor 350, determine one or more characteristics of the tray 106 and/or one or more components of the robotic applicator 300, and execute one or more commands, as described in greater detail herein.

The embodiment of FIG. 3 depicts the sensor 350 as an imaging device, such as a camera or the like. However, it should be understood that other types of sensors may also be used without departing from the scope of the present disclosure. For example, the sensor 350 may be a humidity sensor, a temperature sensor, and/or the like. In another example, the sensor 350 may include a pressure sensor positioned underneath the tray 106 and/or the cart 104 (FIG. 1A) that detects a weight of a portion of the tray 106 and/or the cart 104. In addition, while the embodiment of FIG. 3 merely depicts a single sensor 350, this is also illustrative. In some embodiments, a plurality of sensors may be included.

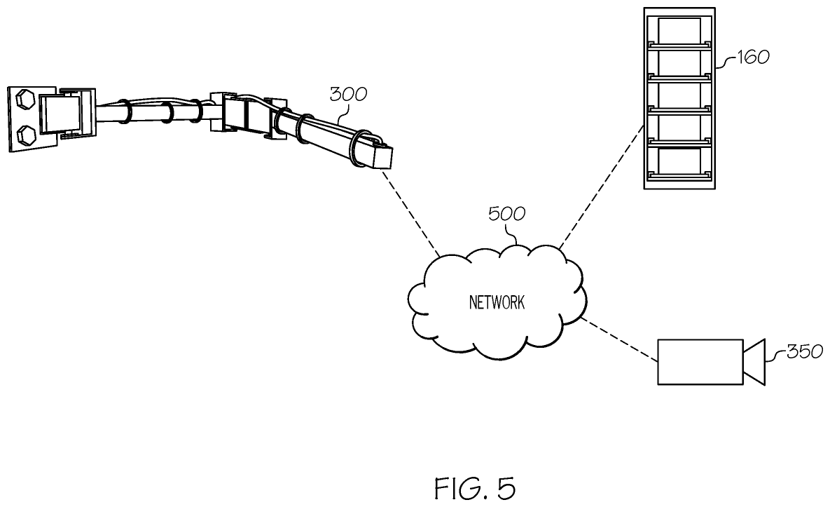

FIG. 5 depicts the master controller 160 (or a component thereof) communicatively coupled to the robotic applicator 300 and a sensor 350 in a communications network 500 according to various embodiments. In some embodiments, the master controller 160 may be communicatively coupled to the robotic applicator 300 and/or the sensor 350 via the communications network 500, as indicated by the dashed lines between the various components. The communications network 500 may include the internet or other wide area network, a local network, such as a local area network, or a near field network, such as Bluetooth or a near field communication (NFC) network. In other embodiments, instead of being connected via the communications network 500, the master controller 160 may be directly connected to the robotic applicator 300 and/or the sensor 350 for the purposes of communications. Communicative coupling, whether via the communications network 500 or via direct connection, may be achieved via one or more wired connections and/or one or more wireless connections.

In some embodiments, communications between the master controller 160, the robotic applicator 300, and the sensor 350 may be such that the master controller 160 provides transmissions, such as data and signals, to the robotic applicator 300 and/or the sensor 350 for the purposes of directing operation. For example, the master controller 160 may receive image data or the like from the sensor 350, determine one or more characteristics from the image data, generate one or more commands, and transmit the one or more commands to the robotic applicator 300 to cause the robotic applicator 300 (and/or one or more components thereof) to move, selectively dispense fluid, selectively dispense seeds, and/or the like, as described herein.

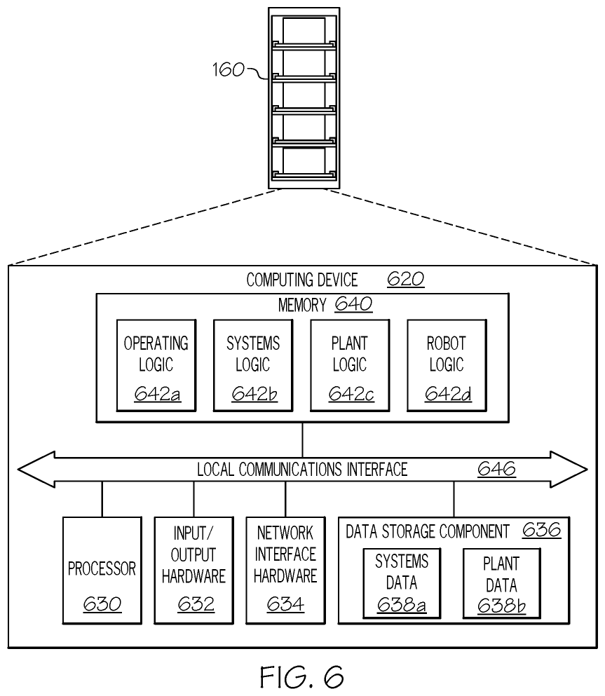

FIG. 6 depicts an illustrative computing environment within the master controller 160 according to one or more embodiments. As illustrated in FIG. 6, the master controller 160 may include a computing device 620. The computing device 620 includes a memory component 640, a processor 630, input/output hardware 632, network interface hardware 634, and a data storage component 636 (which stores systems data 638a, plant data 638b, and/or other data).

At least a portion of the components of the computing device 620 may be communicatively coupled to a local communications interface 646. The local communications interface 646 is generally not limited by the present disclosure and may be implemented as a bus or other communications interface to facilitate communication among the components of the master controller 160 coupled thereto.

The memory component 640 may be configured as volatile and/or nonvolatile memory. As such, the memory component 640 may include random access memory (including SRAM, DRAM, and/or other types of RAM), flash memory, secure digital (SD) memory, registers, compact discs (CD), digital versatile discs (DVD), Blu-Ray discs, and/or other types of non-transitory computer-readable mediums. Depending on the particular embodiment, these non-transitory computer-readable mediums may reside within the master controller 160 and/or external to the master controller 160. The memory component 640 may store, for example, operating logic 642a, systems logic 642b, plant logic 642c, robot logic 642d, and/or other logic. The operating logic 642a, the systems logic 642b, the plant logic 642c, and robot logic 642d may each include a plurality of different pieces of logic, at least a portion of which may be embodied as a computer program, firmware, and/or hardware, as an example.

The operating logic 642a may include an operating system and/or other software for managing components of the master controller 160. As described in more detail below, the systems logic 642b may contain programming instructions for monitoring and controlling operations of one or more of the various other control modules and/or one or more components of the assembly line grow pod 100 (FIG. 1A). Still referring to FIG. 6, the plant logic 642c may contain programming instructions for determining and/or receiving a recipe for plant growth and may further include programming instructions for facilitating implementation of the recipe via the systems logic 642b and/or the robot logic 642d. The robot logic 642d may contain programming instructions for determining and/or directing movement of the robotic applicator 300 (FIGS. 3-4) and/or components thereof.

It should be understood that while the various logic modules are depicted in FIG. 6 as being located within the memory component 640, this is merely an example. For example, the systems logic 642b, the plant logic 642c, and the robot logic 642d may reside on different computing devices. That is, one or more of the functionalities and/or components described herein may be provided by a user computing device, a remote computing device, and/or another control module that is communicatively coupled to the master controller 160.

Additionally, while the computing device 620 is illustrated with the systems logic 642b and the plant logic 642c as separate logical components, this is also an example. In some embodiments, a single piece of logic (and/or or several linked modules) may cause the computing device 620 to provide the described functionality.

The processor 630 (which may also be referred to as a processing device) may include any processing component operable to receive and execute instructions (such as from the data storage component 636 and/or the memory component 640). Illustrative examples of the processor 630 include, but are not limited to, a computer processing unit (CPU), a many integrated core (MIC) processing device, an accelerated processing unit (APU), a digital signal processor (DSP). In some embodiments, the processor 630 may be a plurality of components that function together to provide processing capabilities, such as integrated circuits (including field programmable gate arrays (FPGA)) and the like.

The input/output hardware 632 may include and/or be configured to interface with microphones, speakers, a display, and/or other hardware. That is, the input/output hardware 632 may interface with hardware that provides a user interface or the like. For example, a user interface may be provided to a user for the purposes of adjusting settings (e.g., an amount of nutrients/water to be supplied, a type and amount of ambient air conditions to be supplied, etc.), viewing a status (e.g., receiving a notification of an error, a status of a particular pump or other component, etc.), and/or the like.

The network interface hardware 634 may include and/or be configured for communicating with any wired or wireless networking hardware, including an antenna, a modem, LAN port, wireless fidelity (Wi-Fi) card, WiMax card, ZigBee card, Z-Wave card, Bluetooth chip, USB card, mobile communications hardware, and/or other hardware for communicating with other networks and/or devices. From this connection, communication may be facilitated between the master controller 160 and other components of the assembly line grow pod 100 (FIG. 1A), such as, for example, other control modules, the seeder component 108, the harvesting component 192, the watering component 109, the one or more pumps, and/or the like. In some embodiments, the network interface hardware 634 may facilitate communication between the master controller 160 and other components of the assembly line grow pod 100 (FIG. 1A) via the communications network 500 (FIG. 5). Still referring to FIG. 6, in some embodiments, the network interface hardware 634 may also facilitate communication between the master controller 160 and components external to the assembly line grow pod 100 (FIG. 1A), such as, for example, user computing devices and/or remote computing devices. As such, the network interface hardware 634 may be communicatively coupled to an I/O port of the master controller 160 (not shown).

Still referring to FIG. 6, the master controller 160 may be coupled to a network (e.g., the communications network 500 (FIG. 5)) via the network interface hardware 634. As previously described herein, various other control modules, other computing devices, and/or the like may also be coupled to the network. Illustrative other computing devices include, for example, a user computing device and a remote computing device. The user computing device may include a personal computer, laptop, mobile device, tablet, server, etc. and may be utilized as an interface with a user. As an example, a user may send a recipe to the computing device 620 for at least a partial implementation by the master controller 160. Another example may include the master controller 160 sending notifications to a user of the user computing device.

Similarly, the remote computing device may include a server, personal computer, tablet, mobile device, etc. and may be utilized for machine to machine communications. As an example, if the assembly line grow pod 100 (FIG. 1A) determines a type of seed being used (and/or other information, such as ambient conditions), the computing device 620 may communicate with the remote computing device to retrieve a previously stored recipe for those conditions. As such, some embodiments may utilize an application program interface (API) to facilitate this or other computer-to-computer communications.

Still referring to FIG. 6, the data storage component 636 may generally be any medium that stores digital data, such as, for example, a hard disk drive, a solid state drive (SSD), Optane® memory (Intel Corporation, Santa Clara Calif.), a compact disc (CD), a digital versatile disc (DVD), a Blu-Ray disc, and/or the like. It should be understood that the data storage component 636 may reside local to and/or remote from the master controller 160 and may be configured to store one or more pieces of data and selectively provide access to the one or more pieces of data. As illustrated in FIG. 6, the data storage component 636 may store systems data 638a, plant data 638b, and/or other data. The systems data 638a may generally include data relating to the functionality of the master controller 160, such as stored settings, information regarding the location of the master controller 160 and/or other modules within the master controller 160 (FIG. 1B), and/or the like. The plant data 638b may generally relate to recipes for plant growth, settings of various components within the assembly line grow pod 100 (FIG. 1A), data relating to control of various pumps, valves, and/or components of the robotic applicator 300 (FIGS. 3-4), sensor data relating to a particular tray or cart (e.g., sensor data from the sensor 350 (FIG. 3)), and/or the like.

It should be understood that while the components in FIG. 6 are illustrated as residing within the master controller 160 (and/or a component thereof, such as a control module), this is merely an example. In some embodiments, one or more of the components may reside external to the master controller 160 (or the control module). It should also be understood that, while the master controller 160 is illustrated as a single device, this is also merely an example. That is, the master controller 160 may be a plurality of devices (e.g., a plurality of hot swappable control modules) that are communicatively coupled to one another and provide the functionality described herein.

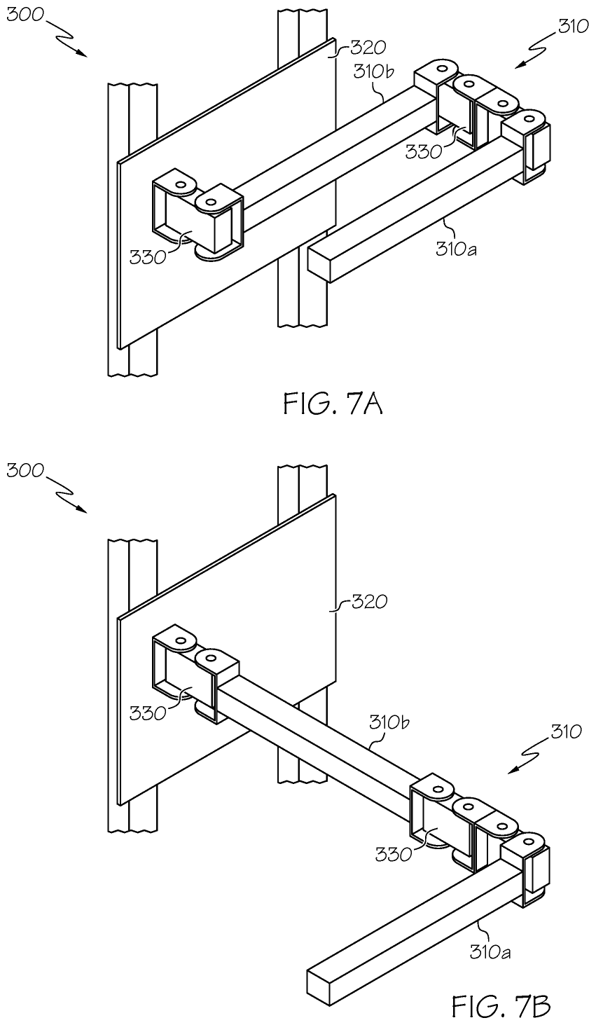

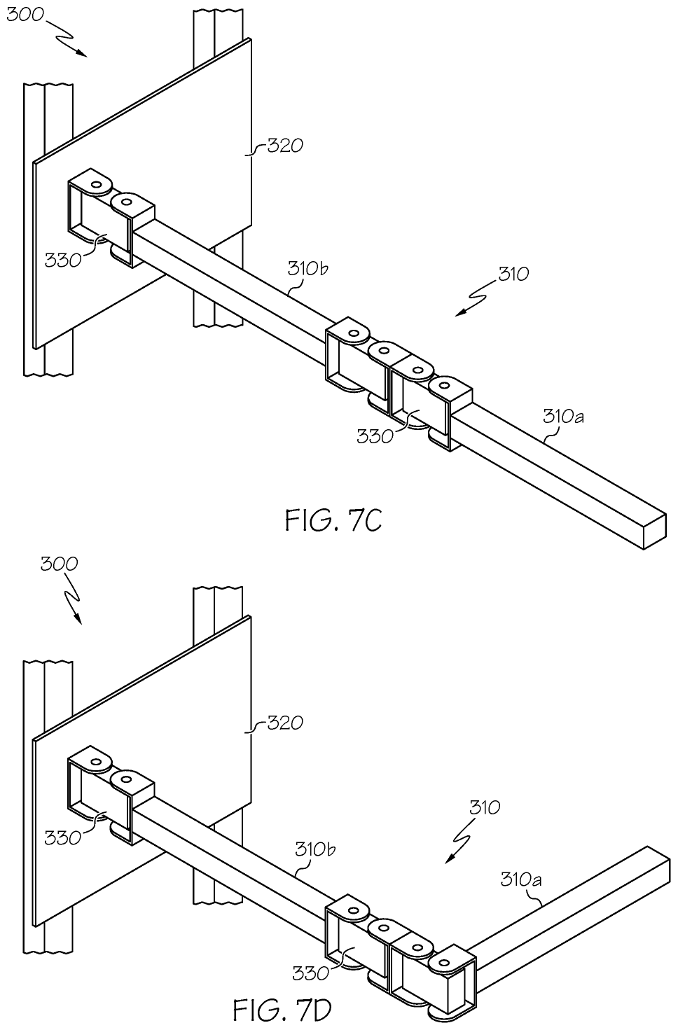

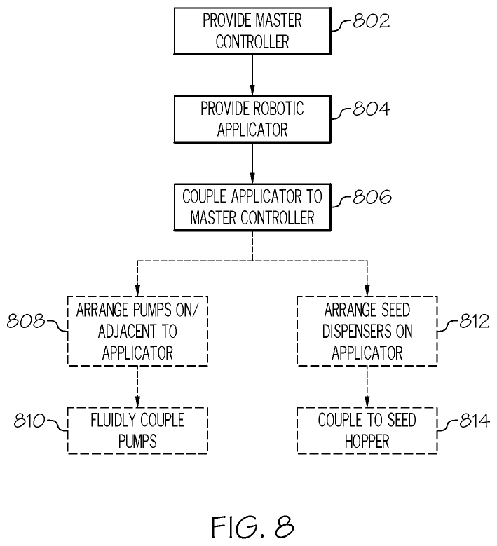

FIG. 7A depicts the articulating robot arm 310 in a retracted position and FIGS. 7B-7D depict the robot arm 310 in various states of extension according to various embodiments. As shown in FIG. 7A, when the articulating robot arm 310 is retracted, the first segment 310a is folded underneath the second segment 310b such that both a length of the first segment 310a and a length of the second segment 310b contact the base 320. That is, as depicted in FIG. 7A, the first segment 310a and the second segment 310b may generally be positioned substantially parallel to the base 320.

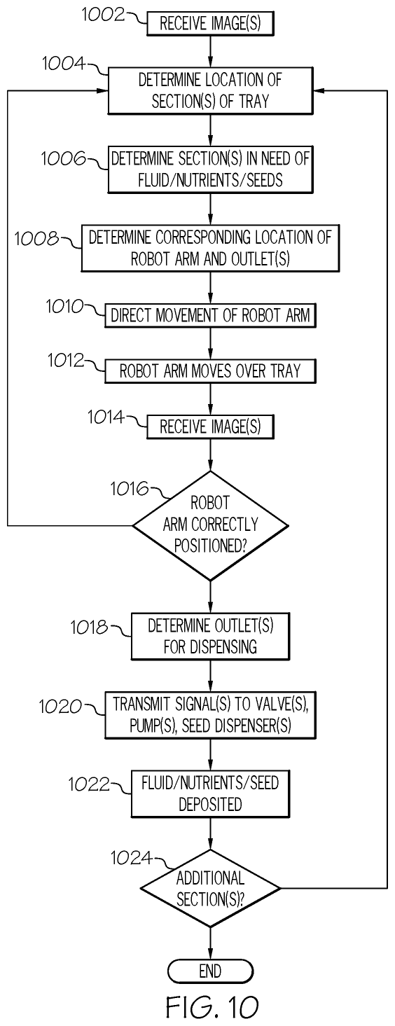

As previously described herein, the first segment 310a and the second segment 310b may be movable at a joint between the second segment 310b and at a joint between the first segment 310a and the second segment 310b via the actuators 330. That is, an actuator 330 may cause the second segment 310b to pivot about the joint between the second segment 310b and the base 320 and another actuator 330 may cause the first segment 310a to pivot about the joint between the first segment 310a and the second segment 310b. Accordingly, as shown in FIGS. 7B-7D, the second segment 310b may pivot in a clockwise direction about the joint between the second segment 310b and the base 320 from the position depicted in FIG. 7A to the position depicted in FIGS. 7B-7D whereby the second segment 310b is substantially orthogonal to the base 320. Further, as shown in FIGS. 7B-7D, the first segment 310a may pivot in a counter-clockwise direction about the joint between the second segment 310b and the first segment 310a from the position depicted in 7A to the position depicted in FIG. 7B, and further to the positions depicted in FIGS. 7C and 7D. Referring to FIGS. 2, 3, and 7A-7D, as a result of the movement of the first segment 310a and the second segment 310b, the articulating robot arm 310 is movable to any position over the tray 106 such that fluid or seeds (or a combination thereof, such as a slurry of water and seeds) can be distributed to any location within the tray 106 (e.g., the various physical sections 206 of the tray 106) by moving the first segment 310a and the second segment 310b such that one or more outlets 340 are positioned over a particular section 206. Such a capability allows for the articulating robot arm 310 to precisely place fluid and/or seeds (e.g., a slurry of fluid and seeds) in a particular section 206 of the tray 106 according to one or more instructions received, and regardless of the configuration of physical sections 206 within the tray 106. That is, the articulating robot arm 310 can easily be adaptable to move such that any amount of seed and/or fluid can be distributed to any section 206 or portion of the tray 106 in a manner that would otherwise not be achievable using a distribution manifold or other means of fluid and/or seed (e.g., slurry) distribution. Additional details regarding this precise movement of the articulating robot arm 310 to achieve specific placement of fluid and/or seed (e.g., a slurry) in the tray 106 or a portion thereof (e.g., in a particular one or more physical sections 206) will be described herein with respect to FIG. 10.

Referring now to FIGS. 1A, 3, and 8, an illustrative method of providing the robotic applicator 300 in the assembly line grow pod 100 is depicted. While also referring to FIGS. 1A-1B and 3-4, the method according to the embodiment of FIG. 8 may generally include providing the master controller 160 at block 802. That is, the master controller 160, including any components thereof, may be provided for the purposes of controlling operation of the various other components, as described herein. In addition, the method further includes providing the robotic applicator 300 at block 806. That is, the various components of the robotic applicator 300, including, but not limited to, the articulating robot arm 310, the base 320, the fluid lines 110, and the outlets 340 are provided according to block 804 for the purposes of distributing fluid and/or seeds (e.g., a slurry of fluid and seeds). At block 806, the robotic applicator 300 is coupled to the master controller 160. More specifically, the robotic applicator 300 (and/or the various components thereof) may be communicatively coupled to the master controller 160 such that signals and/or data can be transmitted between the robotic applicator 300 (and/or the various components thereof) and the master controller 160. For example, the robotic applicator 300 (and/or any component thereof) can be coupled to the master controller 160 via a wired or a wireless connection, such as the wired or wireless connections described herein.

If the robotic applicator 300 dispenses fluid (e.g., water or nutrients), the method may further include the steps of arranging the fluid pumps 150 on or adjacent to the robotic applicator 300 at block 808 and fluidly coupling the fluid pumps 150 to a water supply (e.g., the watering component 109) at block 810. That is, one or more fluid pumps 150 may be added to the fluid lines 110) supplying the fluid that is ejected from the outlets 340 on the articulating robot arm 310 such that fluid can be pumped from a fluid source (e.g., the watering component 109) to the outlets 340. The one or more fluid pumps 150 may be placed in a location between the fluid source (e.g., the watering component 109) and the outlets 340 on the articulating robot arm 310. In addition, the one or more fluid pumps 150 may also be communicatively coupled to the master controller 160 such that signals and/or data is transmitted between the master controller 160 and the one or more fluid pumps 150 (e.g., signals from the master controller 160 directing each of the one or more fluid pumps 150 to open or close).

If the robotic applicator 300 dispenses seeds, the method may further include the steps of arranging seed dispensers (e.g., outlets 340 configured as seed dispensers) on the robotic applicator 300 at block 812 and coupling the seed dispensers to a seed hopper or other similar seed storage device at block 814.

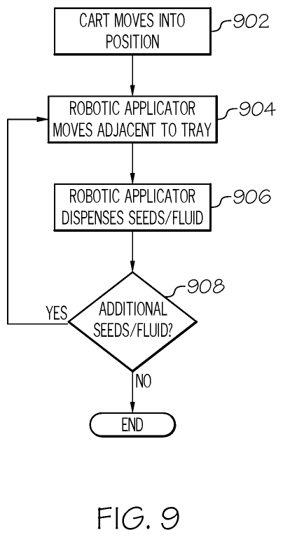

FIG. 9 depicts an illustrative general overview method of applying seeds and/or fluid to a tray in an assembly line grow pod using a robotic applicator 300 according to embodiments. Referring to FIGS. 1A-1B, 3, 4, and 9, at block 902, the cart 104 moves into position under the robotic applicator 300. That is, the cart 104, supporting the tray 106 thereon, moves along the track 102 until the tray 106 is located at a position where the articulating robot arm 310 of the robotic applicator 300 can be moved over top of the tray 106 to dispense seeds and/or fluid. At block 904, the robotic applicator 300 (and/or one or more components thereof) moves adjacent to the tray 106 in a location where seeds and/or fluid are to be dispensed. At block 906, the seeds and/or fluid are dispensed by the robotic applicator 300 into the tray 106. A determination may be made at block 908 as to whether additional seeds and/or fluid are necessary in other parts of the tray 106. If so, the process may return to block 904. Otherwise, the process ends.

FIG. 10 depicts a flow diagram of an illustrative method of providing seeds and/or fluid in greater detail. In embodiments, one or more steps of the method depicted in FIG. 10 may be completed by the master controller 160 (FIG. 1A) and/or a portion thereof (e.g., the computing device 620 (FIG. 6)). As such, references to the master controller 160 with respect to FIG. 10 include the various components of the master controller 160 described herein, including the computing device 620 (FIG. 6) and the various components therein.

Referring to FIGS. 3-5 and 10, one or more images of an area encompassing at least a portion of the tray 106 and/or at least a portion of the robotic applicator 300 are received from the sensor 350 at block 1002. The one or more images are generally received by the master controller 160 when data (e.g., image data corresponding to one or more images captured by the sensor 350) is transmitted to the master controller 160 from the sensor 350 via the communications network 500. It should be understood that other information may also be received from the sensor 350 in some embodiments. For example, humidity information and/or temperature information may be received from the sensor 350 at block 1002. That is, the one or more images may include information that is indicative of a particular slurry humidity, ambient air humidity information, temperature information, and/or the like.

Referring to FIGS. 2-5 and 10, at block 1004, the master controller 160 may determine a location of the one or more physical sections 206 of the tray 106. That is, the master controller 160 may analyze the one or more images received from the sensor 350, determine the relative locations of the various side walls 202 and/or the various interior walls 204 of the tray, and use the determination to map the physical sections 206 of the tray 106. Such a mapping of the physical sections 206 can be used for the purposes of tracking a particular section, determining the dimensions of a section, determining an amount of seed and/or fluid that can be contained within a particular section, determining relative locations of a plurality of sections, and/or the like. Such determinations may be used for later determining where to move the articulating robot arm 310, as described herein.

At block 1006, the master controller 160 may determine one or more physical sections 206 of the tray 106 in need of fluid (e.g., water and/or nutrients) and seeds. That is, the master controller 160 may apply a recipe based on the various characteristics of each of the physical sections 206 for the purposes of directing the distribution of fluid and/or seeds (e.g., a slurry of seeds). For example, the master controller 160 may determine that a particular recipe requires a particular amount of seeds, water, and/or nutrients. The master controller 160 may then use the determined dimensional characteristics of the various physical sections 206 of the tray 106 to determine which physical sections 206 are capable of holding the particular amount of seeds, water, and/or nutrients. In some embodiments, determining one or more physical sections 206 of the tray 106 in need of fluid and/or seeds according to block 1006 may include determining a change in humidity levels of a slurry and/or a surrounding environment based on humidity and/or temperature information received from the sensor 350 and determining one or more physical sections 206 in need of additional fluid to maintain or resume a particular humidity (e.g., altering a growing recipe to supply additional fluid to particular drier regions). In some embodiments, such a determining may be based on growth, historical crop yield, and/or the like.

At block 1008, the master controller 160 may determine where the articulating robot arm 310 should be positioned relative to the tray 106 in order to distribute the determined amount of seeds and/or fluid (e.g., water and/or nutrients) to the determined particular section(s) 206 of the tray 106. That is, the master controller 160 may determine the coordinates of each physical section 206 to receive fluid and/or seeds (e.g., a slurry), determine which portion(s) of the articulating robot arm 310 can reach each physical section 206 (e.g., the first segment 310a, the second segment 310b, one or more of the outlets 340, and/or the like), determine a movement of the articulating robot arm 310 that will cause the corresponding portion(s) of the articulating robot arm 310 to reach each physical section 206, and generate movement instructions for moving the articulating robot arm 310 accordingly. Accordingly, the articulating robot arm 310 (including the components thereof) may be directed to move at block 1010, thereby causing the articulating robot arm 310 to move at block 1012. That is, the master controller 160 transmits one or more signals corresponding to particular movement(s) to the articulating robot arm 310 (or a component thereof, such as, for example, the actuators 330) and the articulating robot arm 310 moves accordingly such that the various outlets 340 are appropriately positioned over a corresponding one or more of the physical sections 206 to dispense fluid and/or seeds (e.g., a slurry) from the outlet(s) 340 into the physical sections 206.

Once the articulating robot arm 310 has moved according to the instructions received from the master controller 160, the master controller 160 may verify that the articulating robot arm 310 and the various components thereof (e.g., the outlets 340) are appropriately positioned with respect to the physical sections 206 of the tray in various embodiments. As such, at block 1014, one or more additional images may be received from the sensor 350. That is, the sensor 350 may transmit additional data (e.g., additional image data) of the area within the field of view thereof (e.g., at least a portion of the tray 106 and/or at least a portion of the robotic applicator 300) to the master controller 160. The master controller 160 may then make a determination as to whether the articulating robot arm 310 is correctly positioned at block 1016. Such a determination may include, for example, determining the coordinates of the articulating robot arm 310 (and/or components thereof, such as each of the outlets 340) and/or the tray 106 (including the physical sections 206 thereof) from the image data and determining whether the coordinates correspond to expected coordinates of the articulating robot arm 310 and or the tray 106. If it is determined that the articulating robot arm 310 is correctly positioned (e.g., the coordinates match), the process may proceed to block 1018. If it is determined that the robot arm 310 is not correctly positioned (e.g., the coordinates do not match), the process may return to block 1004 for further determination and further movement.

At block 1018, the master controller 160 may determine which of the one or more outlets 340 on the articulating robot arm 310 are to dispense seeds and/or fluid therefrom into the physical sections 206 of the tray 106. Such a determination may generally include analyzing the map of the relative location(s) of outlet(s) 340 and section(s) 206 of the tray 106 to match particular section(s) 206 that are to receive seeds and/or fluid with particular outlet(s) 340 positioned above. The master controller 160 may then transmit one or more signals at block 1020 to the various components of the assembly line grow pod 100, including the robotic applicator 300 and the components thereof, to operate accordingly to dispense the appropriate amount of seeds and/or fluid. That is, the master controller 160 may transmit one or more signals to one or more valves, one or more pumps, one or more seed dispensers, and/or the like. As a result of receiving these signals, the various components may operate to deposit the fluid (e.g., water and/or nutrients) and/or seeds (e.g., a slurry of fluid and seeds) at block 1022.

At block 1024, a determination may be made as to whether additional physical sections 206 within the tray 106 are to receive seeds and/or fluid, but have not yet received seeds and/or fluid. If so, the process may repeat at block 1004. Otherwise, the process may end.

As illustrated above, various embodiments for distributing, via a robotic applicator, a precise amount of fluid and/or seeds (e.g., a slurry of fluid and seeds) to a tray (including sections thereof, if present) on a cart supported on a track in an assembly line grow pod are disclosed. As a result of the embodiments described herein, very specific control of fluid and/or seeds supplied to the various sections in a tray (or the tray alone) is achieved, even in instances where the number of pumps and/or seed dispensers does not correspond to the number of sections to be provided with fluid and/or seeds, as well as in instances where the cart supporting the tray is constantly moving along the track. This very specific control of fluid and/or seed distribution via the robotic applicator ensures that only a precise amount of fluid and/or seeds is supplied a particular time, thereby ensuring optimum growth of plant material. In addition, the precise delivery of fluid via the robotic applicator avoids under watering and overwatering, misdirection of water/nutrients, as well as generation of waste water/nutrients. Moreover, the precise delivery of fluid via the robotic applicator reduces or eliminates dripping water being ejected into the sections and/or trays, which may impact the precise amount of fluid needed by a particular plant material.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for providing and operating robotic applicators at one or more watering stations in an assembly line grow pod to ensure the precise placement of fluid and/or seeds. It should also be understood that these embodiments are merely exemplary and are not intended to limit the scope of this disclosure.

What is claimed is:

1. An assembly line grow pod comprising:
a tray held by a cart supported on a track, the tray comprising a plurality of sections, the tray receiving plant material in at least one of the plurality of sections;
a watering component for providing fluid to the tray and plant material; and
a robotic applicator comprising an articulating robot arm having one or more outlets that selectively dispense the fluid therefrom, the articulating robot arm positioned relative to the tray to align the one or more outlets with one or more corresponding section of the plurality of sections such that the fluid is dispensable into each of the sections.

2. The assembly line grow pod of claim 1, further comprising a master controller communicatively coupled to the watering component and the robotic applicator, the master controller transmitting signals to the watering component and the robotic applicator to control delivery of the fluid to the at least one section of the plurality of sections of the tray.

3. The assembly line grow pod of claim 2, further comprising at least one sensor communicatively coupled to the master controller, the at least one sensor transmitting signals or data or both to the master controller for determining a location of the at least one section of the tray relative to the one of the one or more outlets of the articulating robot arm.

4. The assembly line grow pod of claim 3, wherein the at least one sensor includes an imaging device that transmits image data to the master controller.

5. The assembly line grow pod of claim 1, wherein the robotic applicator further comprises a base supporting the articulating robot arm thereon, the base movable relative to the tray.

6. The assembly line grow pod of claim 1, wherein the robotic applicator is positioned adjacent to the track such that, when the cart, when moving along a length of the track, passes the robotic applicator.

7. The assembly line grow pod of claim 1, wherein the articulating robot arm comprises a plurality of segments, a first one of the plurality of segments hingedly coupled to a second one of the plurality of segments via a joint such that the first one of the plurality of segments is movable relative to the second one of the plurality of segments in an articulating manner.

8. The assembly line grow pod of claim 7, wherein the robotic applicator further comprises at least one actuator coupled at the joint to cause the first one of the plurality of sections to move relative to the second one of the plurality of sections.

9. The assembly line grow pod of claim 1, wherein the plurality of sections of the tray include at least one of the following: at least one physical section or at least one virtual section.

10. The assembly line grow pod of claim 1, further comprising one or more flow control valves fluidly coupled between the watering component and the one or more outlets of the articulating robot arm, the one or more flow control valves controlling a flow of fluid from the watering component.

11. The assembly line grow pod of claim 1, further comprising one or more fluid pumps fluidly coupled between the watering component and the one or more outlets of the articulating robot arm, the one or more fluid pumps controlling a pressure and a flow of the fluid from the watering component.

12. The assembly line grow pod of claim 1, further comprising a master controller that receives a signal from a sensor, determines, from the signal, whether the plant material located in at least one of the plurality of sections is in need of water, and in response to determining that the plant material is in need of water, sends a signal to the robotic applicator to provide water to the plant material located in the at least one of the plurality of sections.

13. The assembly line grow pod of claim 1, wherein a predetermined amount of the fluid is deposited via the one or more outlets into the corresponding section according to a grow recipe.

14. The assembly line grow pod of claim 1, wherein the cart moves along a length of the track while the robotic applicator dispenses the fluid into the corresponding section.

15. The assembly line grow pod of claim 1, further comprising a seeder component comprising a second robotic applicator having a second articulating robot arm with one or more second outlets that selectively dispense seeds therefrom.

16. A watering station adjacent to a track carrying a cart supporting a tray, the watering station comprising:
a robotic applicator comprising an articulating robot arm coupled to a movable base;
a plurality of outlets fluidly coupled to a watering component, the watering component providing fluid to the tray;
a sensor positioned to determine a location of one or more of a plurality of sections of the tray, the one or more of the plurality of sections holding plant material; and
a computing device that includes a memory component that stores logic that, when executed by the computing device causes the articulating robot arm to substantially align at least one of the plurality of outlets with one or more respective sections of the plurality of sections of the tray such that a predetermined amount of the fluid is distributed by the at least one of the plurality of outlets into the one or more respective sections of the tray.

17. The watering station of claim 16, wherein the logic further causes the watering station to perform at least the following:
receive sensor data;
determine, from the sensor data, whether the plant material located in at least one of the plurality of sections is in need of water; and
in response to determining that the plant material is in need of water, send a signal to the robotic applicator to provide water to the plant material located in the at least one of the plurality of sections.

18. The watering station of claim 16, wherein the plurality of sections of the tray include a first plurality of sections and a second plurality of sections, the first plurality of sections having a shape and a size that is different from the second plurality of sections and wherein the robotic applicator is configured to independently add water to each of the first plurality of sections and the second plurality of sections based on at least one of the following: a grow recipe or sensor data indicating a watering need.

19. A method of providing a fluid to a tray in an assembly line grow pod, the method comprising:
receiving, by a master controller of the assembly line grow pod, data pertaining to the tray from a sensor communicatively coupled to the master controller;
determining, by the master controller, a plurality of sections of the tray, at least a portion of the plurality of sections of the tray holding plant material;
determining, by the master controller according to a grow recipe, a time to provide water to the each of the plurality of sections of the tray when the tray is positioned over one or more of the plurality of sections; and
directing, by the master controller, fluid to be dispensed from the one or more outlets of the robot arm into the one or more of the plurality of sections of the tray.

20. The method of claim 19, wherein directing the fluid dispensed from the one or more outlets of the robot arm into at least one of the plurality of sections of the tray further comprises determining a particular one or more of the one or more outlets to dispense the fluid and directing the one or more outlets to open to dispense the fluid.
